(19) United States
(12) Patent Application Publication
(10) Pub. No.: US 2026/0235639 A1
(43) Pub. Date: Aug. 13, 2026

(54) APPARATUS AND METHOD FOR PERSONAL STAND-OFF WIND MEASUREMENT DEVICE

(71) Applicant: RD2, LLC, Manassas, VA (US)

(72) Inventors: Priyavadan MAMIDIPUDI, Great Falls, VA (US); Elizabeth A. DAKIN, Jackson, WY (US); Daniel C. DAKIN, Jackson, WY (US); Philip L. ROGERS, Jackson, WY (US); Alisa K. ROGERS, Jackson, WY (US)

(21) Appl. No.: 19/532,193

(22) Filed: Feb. 6, 2026

Related U.S. Application Data
(60) Provisional application No. 63/755,483, filed on Feb. 7, 2025.

(51) Int. Cl. G01P 5/26; G01P 1/07; H04M 1/02

(52) U.S. Cl. CPC G01P 5/26; G01P 1/07; H04M 1/0266; H04M 2250/12

(57) ABSTRACT

An apparatus and method for a stand-off wind measurement device that provides the user with real time wind speed measurement in his/her local vicinity using a Laser Doppler Velocimeter (LDV) sensor. The apparatus may be a mobile phone or other hand-held device that is associated with the LDV sensor. The apparatus is also networked so that not only can it share its local wind data with remote server(s) that also collect real time wind data from other users having hand-held devices with their own respective LDV sensor to provide a more accurate real time wind map to everyone in that vicinity. Moreover, this collected data, when provided by users with similar hand-held devices world-wide, can be used to generate a global wind map in real time.

### CROSS REFERENCE TO RELATED APPLICATIONS

This non-provisional application claims the benefit under 35 U.S.C. §119(e) of Application Serial No. 63/755,483 filed on February 7, 2025 entitled APPARATUS AND METHOD FOR PERSONAL STAND-OFF WIND MEASUREMENT DEVICE and whose entire disclosure is incorporated by reference herein.

### BACKGROUND OF THE INVENTION

This present invention relates to environmental sensors, and more particularly, to a hand-held or wearable device that provides real-time wind speed and direction and even distance ahead of the device using laser-based detection.

Weather reporting and alerts to individuals has become commonplace with the downloading onto individuals’ mobile phones of mobile apps associated with the National Weather Service (NWS) and/or local broadcast stations. These entities have dedicated weather sensors in certain locations from which they can then predict weather patterns. However, as you can surmise, the number of weather sensors can limit the accuracy and resolution of those predicted weather patterns. What if there were a much greater number of weather sensors distributed all over a region that could provide a much more significant number of weather datapoints for making those weather predictions more accurate? In fact, if such weather sensors could be prevalent over a large part of the world, a more accurate real time world-wide weather map could be generated. And where wind plays a life or death factor such as in tornado-prone, hurricane-prone or fire-prone regions, having the most accurate wind predictions in those regions can provide first responders, fire fighters and local residents, etc., with significant lead time to take life-saving precautions or create more effective strategies to deal with these events. And for a sail-boater on the open sea with no internet or cell-phone connection, having the ability to obtain wind information in real time from his/her own hand device can provide him/her with critical data on which direction to travel in next.

Thus, there remains a need for providing individuals with real-time wind speed and direction in the direct vicinity, especially where wind effects are significant, such as high-wind, hurricane-prone, tornado-prone or fire-prone locations.

The present invention solves this problem.

All references cited herein are incorporated herein by reference in their entireties.

### BRIEF SUMMARY OF THE INVENTION

A hand-held device (e.g., a mobile phone, a personal digital assistant, etc.) for measuring wind data in real time is disclosed. The hand-held device comprises: a laser doppler velocimeter (LDV) for detecting air data in real time in a vicinity of a user of the hand-held device; an inertial measurement unit (IMU) that can determine movement data (e.g., pitch, roll, yaw and heading, etc.) of the device; a signal processor for receiving the air data from the LDV and the movement data of the device from the IMU and generating wind speed and direction; a wireless communication interface (e.g., a cellular or wireless network connection, etc.) for sharing said generated wind speed and direction; and a display, associated with the hand-held device, or displaying the real time wind speed and direction to the user.

A system for measuring wind data in real time on a multi-region basis (e.g., coastal, and inland regions, states within a country, several countries on a continent, etc.) is disclosed. The system comprises: a plurality of hand-held devices (e.g., a mobile phone, a personal digital assistant, etc.) that are present in at least one multi-region, each of the hand-held devices comprises: a laser doppler velocimeter (LDV) for detecting air data in real time in the at least one multi-region of a user of the hand-held device; an inertial measurement unit (IMU) that can determine movement data (e.g., pitch, roll, yaw and heading, etc.)of the device; a signal processor for receiving the air data from the LDV and the movement data of the device from the IMU and generating wind speed and direction; a wireless communication interface (e.g., a cellular or wireless network connection, etc.) for sharing the generated wind speed and direction; a display, associated with the hand-held device, or displaying the real time wind speed and direction to the user; and at least one remote server that also collects real time wind data from other users having hand-held devices with their own respective LDV sensor, via the wireless communication interfaces, to provide more accurate real time wind data to the users’ hand-held devices in the at least one multi-region.

A method for measuring wind data in real time in disclosed. The method comprises: associating a laser doppler velocimeter (LDV) with a hand-held device (e.g., a mobile phone, a personal digital assistant, etc.) of at least one user and wherein the LDV detects air data in real time in a vicinity of the at least one user; including an inertial measurement unit (IMU) within the hand-held device, for determining movement data (e.g., pitch, roll, yaw and heading, etc.) of the device; including a signal processor within the hand-held device, coupled to the LDV and IMU, for generating wind speed and direction from the air data and the movement data; including a wireless communication interface (e.g., a cellular or wireless network connection, etc.) within the hand-held device for sharing the generated wind speed and direction; and associating a display with the hand-held device for displaying the real time wind speed and direction to the user.

A method for measuring wind data in real time on a multi-region basis (e.g., coastal, and inland regions, states within a country, several countries on a continent, etc.) is disclosed. The method comprises: providing a plurality of hand-held devices (e.g., a mobile phone, a personal digital assistant, etc.) of users within at least one multi-region and wherein each of the hand-held devices: detects air data in real time in the at least one multi-region using a laser doppler velocimeter (LDV); determines movement of the device using an inertial measurement unit (IMU); generates wind speed and direction from the air data and the movement data using a signal processor; shares the generated wind speed and direction with other users using a wireless communication interface (e.g., a cellular or wireless network connection, etc.); and displays the real time wind speed and direction to the user using a display associated with the hand-held device of the user; and collecting, by at least one remote server, real time wind data from other users’ said hand-held devices in the at least on multi-region via the wireless communication interfaces, for providing more accurate real time wind data to the users’ hand-held devices in the at least one multi-region.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a system diagram of the present invention which uses a laser doppler velocimeter (LDV) for collecting environmental data displays wind data as well transmitting the same data to global computer networks;

FIG. 2 is a functional diagram depicting how the collection of wind data from a large variety of hand-held devices of the present invention contributes to providing wind data world-wide and forming a global wind map; and

FIG. 3 demonstrates how wind data collected from individual user hand-held devices provides not only for individual real time wind data but assists in providing wind data for generating a global wind map.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

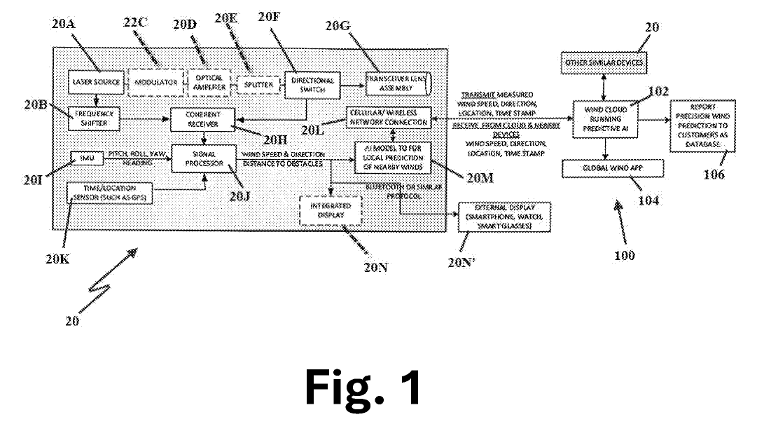

As shown in FIG. 1, the apparatus and method 20 of the present invention uses Laser Doppler Velocimetry (LDV)-based real time wind data collection. Not only does this provide the person with real time wind data in the person’s immediate vicinity but that person’s wind data is shared over a cellular phone network and/or the internet to assist in forming a global wind map in real time. The apparatus 20 is a hand-held device that may comprise a mobile phone, a wristwatch device (e.g., an Apple^{®} watch), PDA, a Tempest^{TM} wind/range sensor, WindSceptor^{TM} 4 wind/range sensor, etc., or it may comprise a device that is separate from these items but wirelessly coupled to these personal items. The term inventive “hand-held device 20” is meant to cover any of these variants.

The apparatus and method 20 of the present invention, as mentioned above is based upon the use of an LDV. The Laser Doppler Velocimeter (LDV sensor) comprises:

photonic integrated circuit (PIC) 20A based laser transmitter operating at or near a wavelength of 1550 nm capable of generating laser signals;

a frequency shifter 20B capable of taking a small percentage of the continuous wave laser signal to create a frequency shifted reference signal;

a modulator 20C capable of generating laser pulses from the continuous wave laser source, if operated in pulsed mode;

an optical amplifier 20D as required, capable of amplifying the continuous wave or pulsed laser signal from the laser source to high powers;

an optical splitter 20E capable of splitting the laser signals into multiple independent laser beams, as required;

a directional optical switch 20F, such as an optical circulator, to direct the transmitter laser light forward towards a transceiver telescope assembly 20G, and to direct the return laser light from the transceiver telescope assembly 20G towards a coherent receiver 20H;

the transceiver lens assembly 20G capable of expanding the laser beam and transmitting the laser signal out of the device 20 towards the measurement volume, and collecting backscattered laser returns from the measurement volume;

an embodiment of this transceiver lens assembly 20G would be that a single transceiver telescope assembly is capable of simultaneously or sequentially transmitting and receiving laser pulses along multiple non-collinear optical paths;

digitization electronics capable of measuring said return signals along each of the receiver channels;

an inertial measurement unit (IMU) 20I capable of tracking the movement of the device 20 (e.g., pitch, roll, yaw, and heading, also referred to throughout this Specification as “movement data”) during the course of the measurement and between measurements;

signal processing algorithms 20J capable of converting the digitized time series data from the optoelectronic receivers 20H into real-time Doppler speed or distance measurements, and combining multiple such measurements over time to compute three-dimensional wind speed and wind direction ahead of the device 20;

the ability to identify the location of the device in real time (such as GPS) 20K;

an internet connection 20L (Wi-Fi, Bluetooth, cellular, satellite, mesh, wireless sensor network or other) that allows the device to communicate with a remotely located data server/ cloud, other wind measurement devices accessible via the network, as well as any compatible internet connected devices to transmit its location as well as winds measurements as well as receive wind measurements made by these other device;,

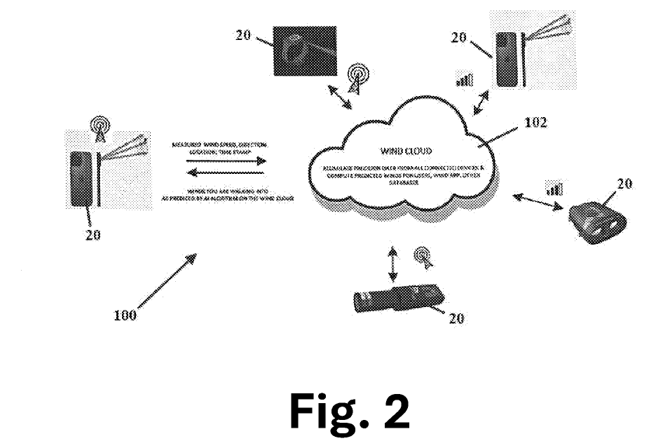

an Artificial Intelligence (AI) model 20M running locally on the device 20 capable of using the wind speed and direction information measured by this device 20, as well as receiving wind speed and wind direction information from an AI predictive model 100 (FIGS. 1-2) run on remote data server(s)/ cloud that is also capable of using the wind speed and direction information measured by multiple devices 22, to generate a precision wind map of the area surrounding the device 20 (or devices 20), and accurately predict wind speed and direction information at locations between devices 20;

as mentioned previously, the device 20 may be incorporated in a single housing or distributed into multiple physical assemblies connected either electronically (e.g., Bluetooth or similar protocol) or optically;

a display 20N with an application (App) capable of presenting the data to the user, either integrated with the device 20 or connected to the device 20 (such as a wearable like a watch); and

an app capable of displaying measured wind speed and direction at the user’s location as well as predicted winds in the area based on measurements of nearby devices 20.

A network 100 of these devices 20 and other wind/ weather measurement devices with real-time data, short term forecasts, and/ or long term wind and/ or weather forecasts being displayed on a custom application (global wind app 104).

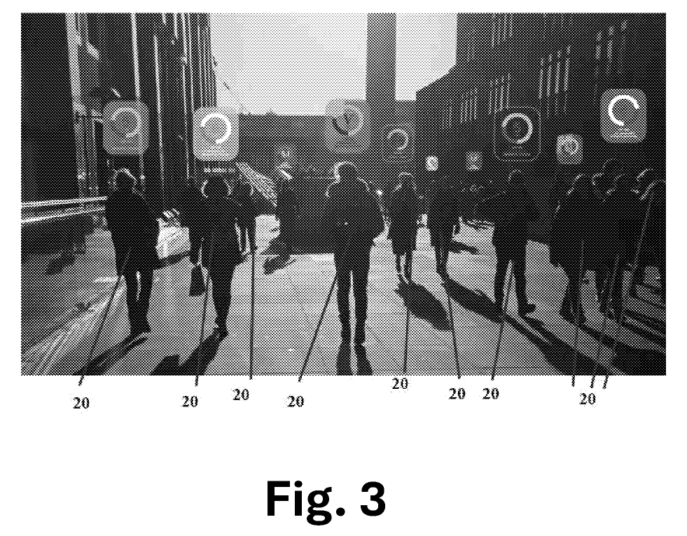

As mentioned above, by in effect allowing everyone’s mobile phone or other hand-held or wearable digital device to have the capability of collecting wind data and sharing the same over the internet (FIG. 3), as well as being able to display local wind maps on the individuals’ devices, a wind data network 100 is effectively formed to provide real time wind data around multi-regions (other than just local vicinities), e.g., the world and provide a global wind app 104. (FIG. 2).

This network can also generate a precision wind prediction report 106 to others who are not on these particular mobile networks.

It should be further noted that because of the use of the LDV in the inventive device 20, that device is also capable of detecting the distance ahead of the device 20, i.e., operate as a range finder.

Applicant incorporates by reference the following patents, all of which are assigned to the same assignee as the assignee of the present application, namely, RD2, LLC: U.S. Patent Nos. 8,508722 (Rogers, et al.); 8,879,051 (Rogers, et al.); 8,930,049 (Rogers, et al.); and 8,961,181 (Rogers, et al.).

While the invention has been described in detail and with reference to specific examples thereof, it will be apparent to one skilled in the art that various changes and modifications can be made therein without departing from the spirit and scope thereof.

What is claimed is:

1. A hand-held device for measuring wind data in real time, said hand-held device comprising:
a laser doppler velocimeter (LDV) for detecting air data in real time in a vicinity of a user of the hand-held device;
an inertial measurement unit (IMU) that can determine movement data of the device;
a signal processor for receiving the air data from the LDV and the movement data of the device from said IMU and generating wind speed and direction;
a wireless communication interface for sharing said generated wind speed and direction; and
a display, associated with the hand-held device, or displaying the real time wind speed and direction to the user.

2. The hand-held device of claim 1 wherein said hand-held device is a mobile phone and said wireless communication interface comprises a cellular or wireless network connection.

3. The hand-held device of claim 2 wherein said display is wirelessly coupled to said mobile phone.

4. The hand-held device of claim 1 wherein said hand-held device is a wearable device.

5. The hand-held device of claim 4 wherein said wearable device is worn on the user’s wrist.

6. The hand-held device of claim 1 further comprising an artificial intelligence (AI) model for predicting nearby winds, said (AI) model using said generated wind speed and direction from said signal processor for displaying the real time wind speed and direction to the user.

7. The hand-held device of claim 6 wherein said AI model using wind data received from said wireless communication interface.

8. A system for measuring wind data in real time on a multi-region basis, said system comprising:
a plurality of hand-held devices that are present in at least one multi-region, each of said hand-held devices comprising:
a laser doppler velocimeter (LDV) for detecting air data in real time in the at least one multi-region of a user of the hand-held device;
an inertial measurement unit (IMU) that can determine movement data of the device;
a signal processor for receiving the air data from the LDV and the movement data of the device from said IMU and generating wind speed and direction;
a wireless communication interface for sharing said generated wind speed and direction;
a display, associated with the hand-held device, or displaying the real time wind speed and direction to the user; and
at least one remote server that also collects real time wind data from other users having hand-held devices with their own respective LDV sensor, via said wireless communication interfaces, to provide more accurate real time wind data to said users’ hand-held devices in the at least one multi-region.

9. The system of claim 8 wherein each one of said hand-held device is a mobile phone and said wireless communication interface comprises a cellular or wireless network connection.

10. The system of claim 9 wherein said display is wirelessly coupled to said mobile phone.

11. The system of claim 8 wherein said hand-held device is a wearable device.

12. The system of claim 11 wherein said wearable device is worn on the user’s wrist.

13. The system of claim 8 wherein each one of said hand-held devices comprises an artificial intelligence (AI) model for predicting nearby winds, said (AI) model using said generated wind speed and direction from said signal processor for displaying the real time wind speed and direction to the user.

14. The system of claim 8 wherein said at least one remote server comprises a predictive artificial intelligence (AI) model for generating said more accurate real time wind data for at one multi-region.

15. The system of claim 14 further comprising a database that provides access to said more accurate real time wind data for users whose hand-held devices using wireless protocols other than cellular or wireless network connection.

16. A method for measuring wind data in real time, said method comprising:
associating a laser doppler velocimeter (LDV) with a hand-held device of at least one user and wherein said LDV detects air data in real time in a vicinity of the at least one user;
including an inertial measurement unit (IMU) within said hand-held device, for determining movement data of said device;
including a signal processor within said hand-held device, coupled to said LDV and IMU, for generating wind speed and direction from said air data and said movement data;
including a wireless communication interface within said hand-held device for sharing said generated wind speed and direction; and
associating a display with said hand-held device for displaying the real time wind speed and direction to the user.

17. The method of claim 16 wherein said hand-held device is a mobile phone and said wireless communication interface comprises a cellular or wireless network connection.

18. The method of claim 17 wherein said display is wirelessly coupled to said mobile phone.

19. The method of claim 16 wherein said hand-held device is a wearable device.

20. The method of claim 19 wherein said wearable device is worn on the user’s wrist.

21. The method of claim 16 wherein said step of including said signal processor within said hand-held device comprises feeding said generated wind speed and direction to an artificial intelligence (AI) model for predicting nearby winds, said (AI) model using said generated wind speed and direction for displaying the real time wind speed and direction to the user.

22. The method of claim 21 wherein said AI model uses wind data received from said wireless communication interface.

23. A method for measuring wind data in real time on a multi-region basis, said method comprising:
providing a plurality of hand-held devices of users within at least one multi-region and wherein each of said hand-held devices:
detects air data in real time in the at least one multi-region using a laser doppler velocimeter (LDV);
determines movement of said device using an inertial measurement unit (IMU);
generates wind speed and direction from said air data and said movement data using a signal processor;
shares said generated wind speed and direction with other users using a wireless communication interface; and
displays the real time wind speed and direction to the user using a display associated with said hand-held device of the user; and
collecting, by at least one remote server, real time wind data from other users’ said hand-held devices in the at least on multi-region via said wireless communication interfaces, for providing more accurate real time wind data to said users’ hand-held devices in the at least one multi-region.

24. The method of claim 23 wherein each one of said hand-held device is a mobile phone and said wireless communication interface comprises a cellular or wireless network connection.

25. The method of claim 24 wherein said display is wirelessly coupled to said mobile phone.

26. The method of claim 23 wherein said hand-held device is a wearable device.

27. The method of claim 26 wherein said wearable device is worn on the user’s wrist.

28. The method of claim 23 wherein said step of generating the wind speed and direction comprises including an artificial intelligence (AI) model for predicting nearby winds, said (AI) model using said generated wind speed and direction from said signal processor for displaying the real time wind speed and direction to the user.

29. The method of claim 23 wherein said step of collecting real time wind data further comprises said at least one remote server using a predictive artificial intelligence (AI) model for generating said more accurate real time wind data for at one multi-region.

30. The method of claim 29 further comprising the step of feeding said more accurate real time wind data to a database for users whose hand-held devices use wireless protocols other than cellular or wireless network connection.
